(19) United States
(12) Patent Application Publication
(10) Pub. No.: US 2004/0081048 A1
(43) Pub. Date: Apr. 29, 2004

(54) Local track pitch measuring apparatus and method

(76) Inventor: Wilhelmson Ulf, Malmo (SE)

Correspondence Address: Steven S. Payne, Law Office of Steven S. Payne, 8027 ILIFF Drive, Dunn Loring, VA, 22027, US

(21) Appl. No.: 10/277,901

(22) Filed: Oct. 23, 2002

(51) Int. Cl. G11B 7/00

(52) U.S. Cl. 369/53.22

(57) ABSTRACT

A local track pitch measuring apparatus is disclosed for an optical disk of the type that stores optically readable information in the form of a spiral or annular pattern defining a plurality of essentially concentric tracks. The apparatus has a laser light source and a drive mechanism which projects a laser beam spot from the laser light source onto a surface of the optical disk and moves the projected laser beam spot radially over a portion of the disk surface across at least some of the tracks. A light detector detects a diffraction or reflection from the projected laser beam spot during its movement. The light detector produces a time variant measurement signal having a periodicity associated with the passages of the moving laser beam spot across respective tracks. A processing device determines a local deviation in the periodicity of the measurement signal and provides an output indicative of a local track pitch for the spiral or annular pattern.

### TECHNICAL FIELD

Generally, the present invention relates to test equipment for optical data carriers, and more specifically to an apparatus and method for measuring local variations in track pitch, i.e. transversal distance between two adjacent tracks, for an optical disk of the type that stores optically readable information in the form of a spiral or annular pattern defining a plurality of essentially concentric tracks.

### DESCRIPTION OF THE PRIOR ART

Optical data carriers are used for storing very large amounts of digital information, which represent for instance music, images or digital data for computers, such as program files and data files. The most common type of optical data carriers is the compact disk, which is available in several different data formats, among which CD-Audio, CD-ROM, CD-ROM XA, CD-I, CD-R and CD-RW are the most common. The standard for compact disks was established some decades ago and has been in use ever since. In recent years, more sophisticated types of optical data carriers have been introduced; DVD (Digital Versatile Disk) and SACD (Super Audio CD).

A common feature of the compact disks above is that they store very large amounts of information on a small surface. The digital information is read at high precision by means of a laser beam, and even if the information is stored on the compact disks according to error-correcting encoding methods, there is a large demand among manufacturers and distributors of compact disks to be able to quality check the production of the compact disks. It is an absolute requirement to fulfill the specifications from Philips and Sony for CD, and from The DVD Group for DVD, so as to ascertain a minimal number of errors and deficiencies among the compact disks, mainly in their information-carrying layer.

When checking the quality of compact disks, a variety of parameters are measured and registered, both physical parameters (such as skewness, eccentricity, cross talk, etc.) and logical errors (various rates of bit errors, block errors and burst errors). Other important parameters are the degree of birefringence in the transparent plastic layer of the compact disk and so-called jitter, i,e. statistical time variations in the signal obtained when reading or playing the compact disk.

As is generally known, a normal audio CD is based on an about 1.2 mm thick plastic disk having a diameter of 12 cm. The plastic disk is normally manufactured as an injection-molded piece of clear polycarbonate plastic. During manufacturing, the plastic disk is impressed with microscopic bumps arranged as a single, continuous spiral pattern that represents the information stored on the CD. A stamper is used for impressing this spiral pattern of microscopic bumps. Once the clear piece of polycarbonate disk has been formed, a thin reflective aluminium layer is sputtered onto the disk, thereby covering the spiral pattern of bumps. Then, a thin photopolymer layer is applied to the aluminium to protect it. Finally, a CD label is printed onto the photopolymer layer.

The bumps in the spiral pattern are normally referred to as pits, since this is how they appear when viewed from the aluminium layer. The areas between adjacent pits are normally referred to as lands or plane areas.

Each turn or revolution of the continuous spiral pattern essentially forms a circular track, which is concentric with the following turn or revolution of the spiral pattern. Therefore, a CD is often described as having a plurality of circular tracks, even if they in reality are coupled to each other in a single continuous spiral pattern. A CD has about 22,000 tracks, whereas a DVD has about 50,000 tracks. In a CD, the distance between adjacent tracks shall be 1.6 μm according to the specifications. In a DVD, the distance between adjacent tracks is specified to be 0.74 μm. The distance between adjacent tracks is normally referred to as track pitch and is labeled TRP in FIGS. 1 and 2.

FIG. 1 illustrates an optical disk 1, such as a CD or DVD, with its single continuous spiral pattern 2 of pits and plane areas. As described, the spiral pattern forms a plurality of essentially concentric circular tracks 3. The optical disk 1 has a center opening 5 for engagement with a drive spindle to rotate the optical disk 1.

FIG. 2 illustrates a few tracks 3 in more detail. The pits (or bumps) are indicated at 6, whereas the intermediate plane areas (or lands) are indicated at 7.

As already mentioned, a stamper is used when producing CDs. A disk master is the geometrical origin of a stamper and may be produced by applying a thin layer of photoresist or another removable material onto a glass disk. A mastering device is continuously moved radially from the center of the glass disk towards its periphery and exposes the photoresist layer in a pattern which corresponds to the desired spiral pattern of pits and plane areas on the end product, i.e. the CD.

It is very important to maintain a constant speed of movement for the mastering device when producing the master. Should even a momentary deviation occur in the speed of movement, this will result in a locally incorrect track pitch, which is either shorter or longer than the desired track pitch (i.e., 1.6 μm for a CD or 0.74 μm for a DVD) and which will be transferred to all CDs produced from the master This phenomenon is indicated in an area 4 in FIG. 1, where it appears that the local track pitch is different from the correct track pitch TRP of the optical disk 1. Correspondingly, FIG. 2 illustrates a pair of adjacent tracks 3′ having an incorrect track pitch TRPₑᵣᵣₒᵣ, which is less than the desired track pitch TRP of 1.6 μm and 0.74 μm, respectively.

Such a deviation in local track pitch may cause problems when reading the information represented by the pits and plane areas in the spiral pattern 2. The problem is particularly pronounced when a three-beam method is used for tracking servo control purposes. Such three-beam methods are very frequently used within the technical field. In its introductory portion, U.S. Pat. No. 5,815,473 gives an overview of a previously known three-beam method for tracking servo control. In summary, an optical pickup device for accessing an optical disk requires a tracking servo control, which allows a beam of emitted laser light to trail the spiral track pattern of the optical disk to the exact position when recording, playing or erasing information on the optical disk. By the tracking servo control, a tracking error is detected based on reflection beams from spots on the optical disk, so that the tracking error of the spot may be corrected to direct the light beam to the exact position of the track of the optical disk.

As is shown in FIG. 1 of aforesaid U.S. Pat. No. 5,815,473, a beam of laser light emitted by a laser diode enters a collimator lens. A parallel beam from the collimator lens enters a diffraction grating, wherein the parallel beam is divided into a number of diffracted light beams. The diffracted light beams leaving the grating pass through a beam splitter. The diffracted light beams enter an objective lens, and converging diffracted light beams leave the objective lens, so that three very small spots of the diffracted light beams hit a surface on the optical disk.

As shown in FIG. 2 of aforesaid U.S. Pat. No. 5,815,473, the main spot has a central position among these three spots and is used when recording, playing or erasing information on the optical disk. Moreover, the main central spot is used for focus error detection. The main spot in formed by a zero-order diffracted light beam leaving the diffraction grating.

The remaining two spots are satellite spots which are used for tracking error detection. The satellite spots are formed by first-order diffracted light beams leaving the diffraction grating. When the three-beam method is utilized, the tracking error is determined by detecting a difference between the intensities of the reflection beams from the two satellite spots on the optical disk.

For a standard CD, having a track pitch of 1.6 μm, the two satellite spots on the optical disk are arranged to be positioned about 0.4 μm from the center of the track. In order to provide a high level of accuracy of the tracking error detection, it is necessary that the rate of change of the intensity of the reflection beams from the satellite spots reaches maximum at the positions where the satellite spots are positioned.

The three-beam tracking error detection method is sensitive to variations from the correct track pitch, particularly if the distance between two adjacent tracks is narrow enough for one of the satellite spots to interfere with the adjacent track.

It is therefore highly desired to be able to detect variations in local track pitch for optical disks.

Previously, manufacturers of compact disks have used visual inspection in order to examine an optical disk for any variations in local track pitch. To this end, the optical disk will be irradiated with a special light, such as light from a halogen lamp. Even it at least a considerable variation in local track pitch will be visually apparent when exposing the optical disk to this light, it has been difficult to provide an estimation of the magnitude of the local track pitch error.

### SUMMARY OF THE INVENTION

The present invention seeks to provide an improved and automatized method of measuring local track pitch for an optical disk.

This object has been achieved by an apparatus and a method according to the enclosed independent patent claims.

According to a preferred embodiment, a local track pitch measuring apparatus is provided for an optical disk of the type that stores optically readable information in the form of a spiral or annular pattern defining a plurality of essentially concentric tracks. The apparatus has a laser light source and a drive mechanism, which projects a laser beam spot from the laser light source onto a surface of the optical disk. Moreover, the drive mechanism causes the projected laser beam spot to move radially over the disk surface across the tracks. A light detector is positioned to detect a diffraction or reflection from the projected laser beam spot during its movement. The light detector produces a time variant measurement signal having a periodicity associated with passages of the moving laser beam spot across respective tracks. Advantageously, the time variant measurement signal is a Radial Error (RE) or Radial Contrast (RC) signal. A processing device or controller, such as a microprocessor (CPU) with associated software, determines a local deviation in the periodicity of the measurement signal and in response provides an output indicative of a local track pitch for the spiral or annular pattern.

Other objects, features and advantages of the present invention will appear more clearly from the following detailed disclosure of a preferred embodiment.

### BRIEF DESCRIPTION OF THE DRAWINGS

A preferred embodiment of the present invention will now be described with reference to the accompanying drawings, in which:

FIG. 1 is a schematic illustration of an optical disk and a continuous spiral pattern forming a plurality of concentric tracks,

FIG. 2 is a schematic illustration of a small area of a few of the tracks on the optical disk of FIG. 1,

FIG. 3 is a schematic block diagram of a local track pitch measuring apparatus according to the invention,

FIG. 4 is a schematic block diagram of a laser scan unit indicated in FIG. 3,

FIG. 5 illustrates a one-beam radial scan detection principle, which may be used in conjunction with a preferred embodiment of the invention,

FIG. 6 illustrates another aspect of the radial scan detection principle,

FIG. 7 is a schematic flowchart diagram of a local track pitch measuring method according to the invention, and

FIG. 8 illustrates an alternative radial scan detection principle.

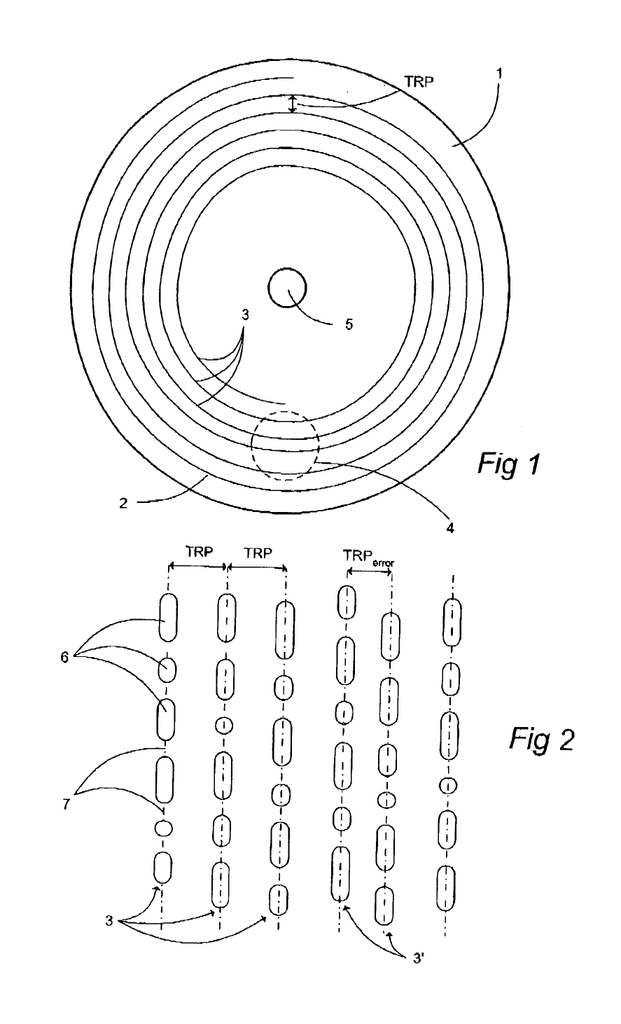

### DETAILED DISCLOSURE

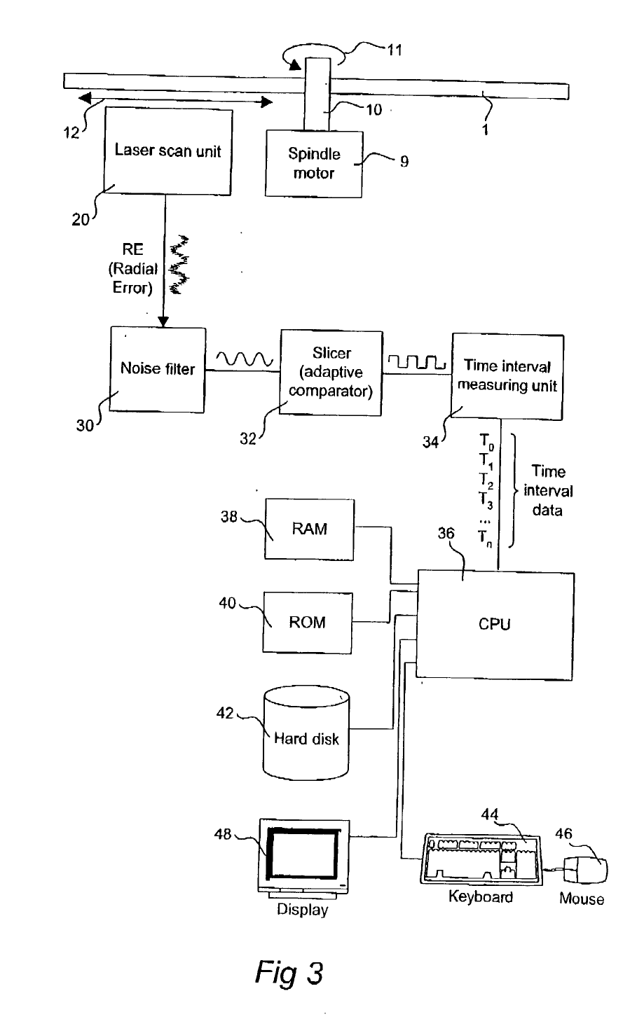

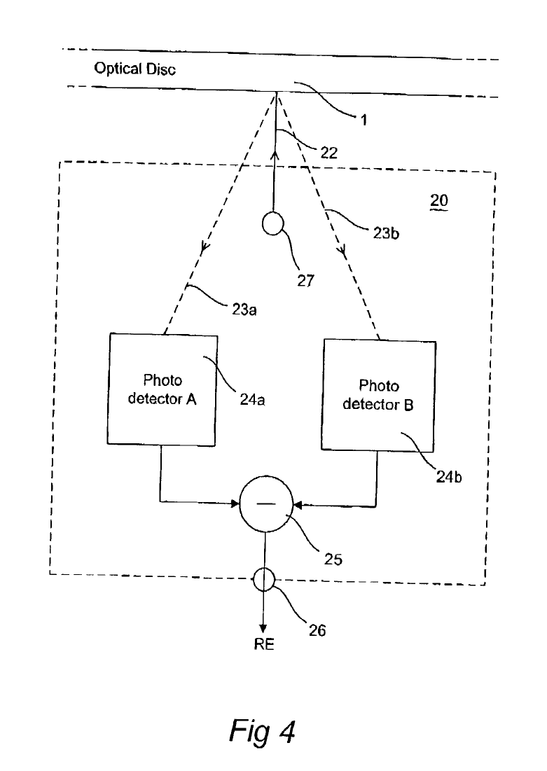

FIG. 3 gives an overview of a local track pitch measuring apparatus according to a preferred embodiment. A disk drive 9, 10 in the form of a spindle motor 9 and a rotatable spindle 10 is adapted to rotate the optical disk 1 in a direction indicated by 11 in FIG. 3, in a manner which is well know in the art. A laser scan unit 20 is positioned close to one surface of the optical disk 1 and is movable in a radial direction of the optical disk 1, as is indicated by 12 in FIG. 3. The laser scan unit, which is illustrated in more detail in FIG. 4, operates to irradiate the surface of the optical disk 1 with a radially sweeping beam of laser light, detect reflections from the surface of the optical disk, produce a time-varying measurement signal in response thereof and provide this signal, labeled RE—Radial Error in the drawings, at an output terminal 26 indicated in FIG. 4. During the radial scan, the optical disk 1 will be kept in rotation by the disk drive (spindle motor 9 and spindle 10). The time-variant output signal RE from the laser scan unit 20 is filtered in a noise filter 30 (standard low pass filter) and fed to an adaptive comparator or slicer 32, which produces a squarewave signal, as indicated in FIG. 3.

The output from the adaptive comparator or slicer 32 is supplied to a time interval measuring unit 34, which uses the time-variant RE signal so as to determine a sequence of time differences between successive full periods of the signal, wherein local variations in these time differences (i.e., deviations in periodicity of the RE signal) are indicative of local variations in track pitch, as will be described in more detail later.

The result from the time interval measuring unit 34 is supplied to a controller or processing device 36, which is coupled to a RAM memory 38, a ROM memory 40 and a hard disk 42, as is indicated in FIG. 3. The controller 36 is also connected to input devices such as a keyboard 44 and a mouse 46, as well as to an output device such as a display 48. As will be described in more detail in the following, the controller 36 will execute a local track pitch determining algorithm by executing programs instructions stored in any of the memories 38, 40 or 42. The local track pitch determining algorithm will determine a local track pitch in response to the time-varying measurement signal (RE) obtained by the laser scan unit 20.

The controller 36 may be implemented by any commercially available microprocessor. Alternatively, the controller 36 may be substituted for another suitable type of electronic logic circuitry, for instance an application-specific integrated circuit (ASIC). Correspondingly, the memories 38, 40, 42, the input devices 44, 46 and the output device 48 may all be implemented by commercially available components and are not described in any detail herein.

Referring now to FIG. 4, the laser scan unit 20 of FIG. 3 will be described in more detail. In addition to the components indicated in FIG. 4, the laser scan unit 20 also contains mechanical drive means for causing the optical assembly of the laser scan unit 20 to move radially along the surface of the optical disk 1 in the direction 12 indicated in FIG. 3. However, such mechanical drive means are well known per se in the technical field, and it is left to the skilled person to choose the suitable mechanical and electrical components (such as an electric motor and a mechanical carriage arrangement), depending on an actual application. In essence, any equipment will do, which is capable of causing the optical components of the laser scan unit 20 to move with high precision in the desired radial direction.

As seen in FIG. 4, the optical components of the laser scan unit 20 comprises a laser light source 27 capable of focusing a laser beam 22 onto the surface of the optical disk 1. The laser source 27 may be chosen among a variety of commercially available components and may operate in a desired wavelength range, for instance at about 800 nm. First order diffraction patterns 23a and 23b will be detected by a photo detector pair 24a, 24b. After conventional conversion to respective electric out put signals, the difference between them will be produced (reference numeral 25 in FIG. 4) and provided as an out put radial error, RE, at a terminal 26. The radial error signal RE is illustrated in FIG. 6.

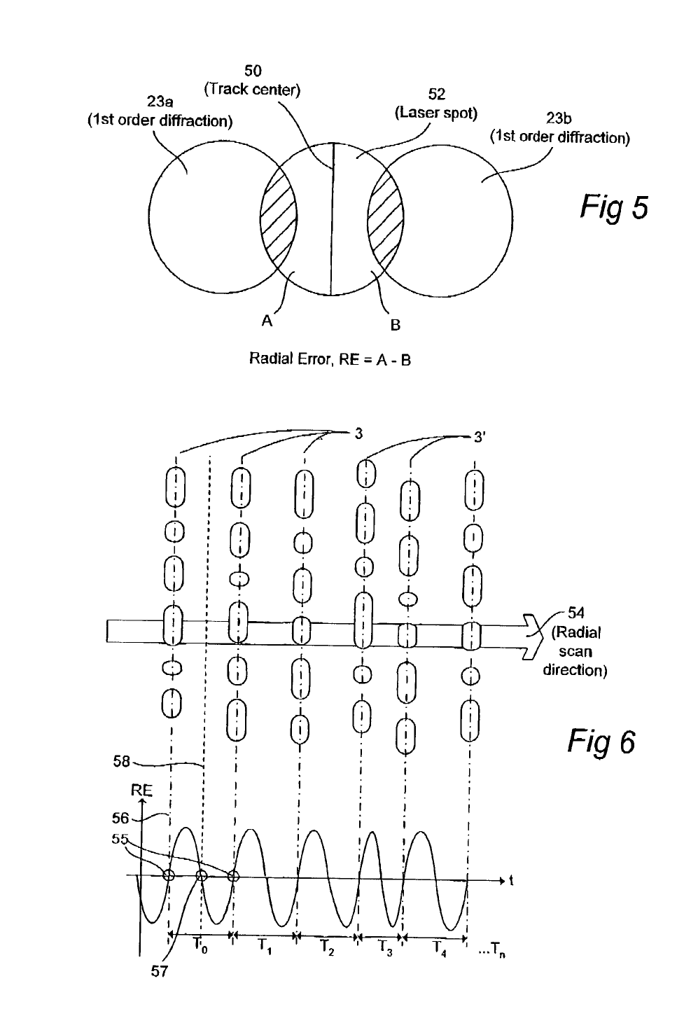

FIG. 5 illustrates the operating principle of the optical components of the laser scan unit 20. As seen in FIG. 5, the radial error signal RE will be calculated as A-B, where A is the result of the detection of the first order diffraction 23a, as produced by the photo detector 24b. Correspondingly, B is the result of the first order diffraction 23b, as produced by the photo detector 24b. Consequently, the terminal 26 of the laser scan unit 20 will provide its output signal RE as an indication of the difference in amount of light detected for the left and right vertical halves of the laser spot 52 on opposite sides of the track center 50.

As seen in FIG. 6, when the radial scan mechanism of the laser scan unit 20 moves the optical detection assembly 24a-b, 25, 27 in a radial direction 54 across the surface of the optical disk 1, the resulting output signal RE from the laser scan unit 20 will be sinusoidal with zero crossings 55 whenever the scanning laser beam 22 crosses the centers 56 of the respective tracks 3, as seen at the bottom of FIG. 6. The distance Tᵢ between a zero crossing for track i and the zero crossing for its preceding track i-1 corresponds to a full period of the RE signal; As shown in FIG. 6, the RE signal contains intermediate zero crossings 57 where the scanning laser beam 22 passes the center 58 of the flat area between adjacent tracks. Such intermediate zero crossings 57 are however differentiated from the zero crossings 55 by an opposite derivative value.

The successive time differences or full periods T₀, T₁, T₂, . . . Tₙ will be used by the controller 36 for determining a momentary value of the local track pitch, as will be described in more detail in the following.

In case the optical disk 1 exhibits any amount of eccentricity, the resulting radial error signal RE will be modulated in frequency. However, the frequency modulation of the RE signal will have considerably slower frequency variations than a local error in track pitch.

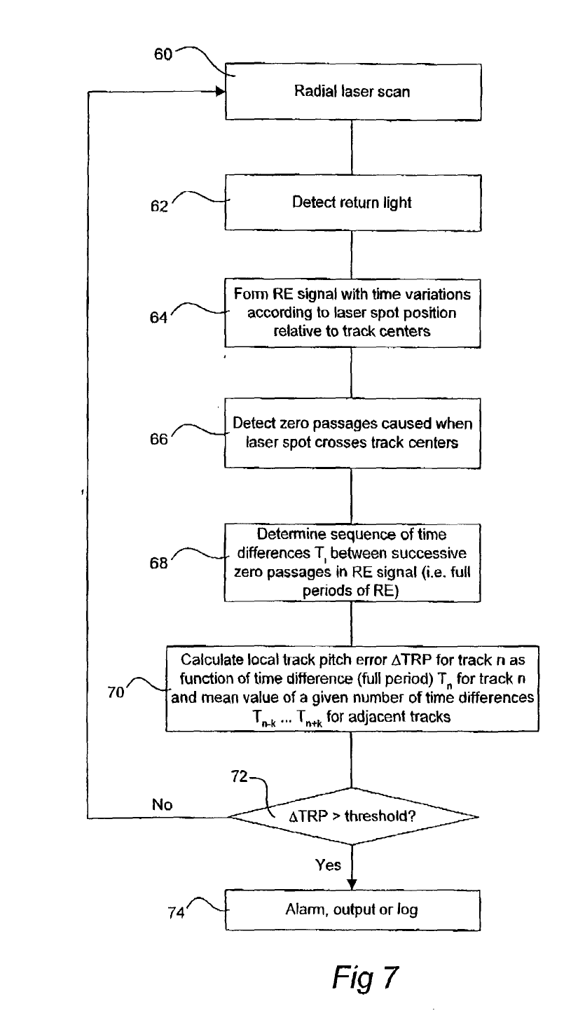

With reference to FIGS. 6 and 7, the controller 36 of FIG. 3 is programmed, in the preferred embodiment, to perform a local track pitch determining algorithm by reading a set of program instructions stored in any of the memories 38, 40 or 42 and executing the program instructions sequentially. In the flowchart of FIG. 7, the introductory steps 60, 62 and 64 represent the operations carried out by the laser scan unit 20, noise filter 30 and adaptive comparator (slicer) 32, as described above.

Next, the time interval measuring unit 34 will detect the zero passages 55 caused by the laser spot 22/52 when passing radially over the centers 56 of the tracks 3 (step 66). The time interval measuring unit 34 will also determine successive time differences Tᵢ (where i=0, 1, 2, 3, 4, . . . , n in FIG. 6) between successive zero passages 55 in the RE signal produced by the laser scan unit 20 (step 68). Thus, the successive time differences Tᵢ represents the successive full periods of the RE signal. The sequence of time differences Tᵢ are supplied to the controller 36 in step 68.

Then, in a step 70 the controller 36 will produce a local track pitch error value ΔTRPₙ for track No. n as a function of the time difference between track n and track n−1, and of a mean value of a given number of time differences Tₙ₋ₖ . . . Tₙ₊ₖ for 2k+1 successive tracks.

In the preferred embodiment, the momentary local track pitch error ΔTRPₙ is calculated according to the following formula:

$$Δ {TRP}_{n} = TRP \cdot \frac{{T}_{n} - \frac{{\sum }_{m - n - k}^{n + k} {T}_{m}}{2 k + 1}}{\frac{{\sum }_{m = n - k}^{n + k} {T}_{m}}{2 k + 1}} ,$$

where k is set to a suitable number of samples, such as k=32, k=64 or k=128. However, other values of k are equally possible. TRP in the above formula represents a reference value of the local track pitch for the optical disk type in question, such as a predetermined normal value (possibly measured by separate means) or a calculated geometrical mean value for the entire disk. Thus, in case there is no momentary deviation in local track pitch at track n, the above formula will yield ΔTRPₙ=0 for that track.

In step 72 the controller 36 checks whether the momentary local track pitch error ΔTRPₙ exceeds a predetermined threshold. If not, the execution is returned to the beginning of step 60. On the other hand, if the local track pitch error ΔTRPₙ for track n actually exceeds the threshold, the controller may generate an alarm or provide another type of output through e.g. the display 48 in a step 74. Alternatively, the controller 36 may simply log all such detected excessive local track pitch errors ΔTRPₙ on the hard disk 42 for later off-line use.

The controller 36 may either process the RE signal for the entire optical disk 1 in one continuous procedure (requires larger data volumes), or process only a smaller amount of information relating to a portion of the optical disk 1, and then fetch measurement information related to a new portion of the optical disk 1, and so on. Moreover, it is not necessary to scan the entire surface of the optical disk 1; in some applications it may be sufficient to scan only a portion of the surface. In particular, this may be necessary in a case where the mechanical components of the laser scan unit 20 comprise a carriage having a lens actuator for focusing and fine tracking. In this case, the carriage will typically be used for coarse radial positioning of the laser scan unit 20 with respect to the optical disk 1, whereas the lens actuator will be displaced so as to cover a small portion (about 1 mm maximum) of the optical disk radius. After having displaced the lens actuator to its maximum extent, and consequently performed a fine radial positioning of the laser scan unit 20, the carriage will be displaced to a new radial position with respect to the optical disk 1.

An effect of such a procedure will be that the resulting measurement signal RE from the laser scan unit 20 will be modulated in frequency by a sinusoidal feeding signal, since the lens actuator will be fed by a sinusoidal waveform. Such frequency modulation effects must be compensated for. This approach may also be used for obtaining a detailed study of a surface area, which has been identified as containing a local trace pitch problem in a previous radial scan across the entire disk surface.

The local track pitch may be calculated in other ways than through the previously mentioned formula. One example of an alternative formula is:

$${LTRP}_{n} = TRP \cdot \frac{{T}_{n}}{\frac{{\sum }_{m = n - k}^{n + k} {T}_{m}}{2 k + 1}} ,$$

where TRP is a predetermined normal track pitch value for the optical disk (1), LTRPₙ is a local track pitch value for a track n, T represents the sequence of time differences and k is an integer value.

Even if the description above has referred to an optical disk having a single continuous spiral pattern of pits and plane areas, forming in essence a large number of concentric interconnected tracks, it is envisaged that the present invention may also be applied to other optical media, containing not a single spiral pattern but a plurality of non-connected circular or annular information tracks.

It is also envisaged that the local track pitch measuring method of the invention may be embodied as a computer program product, which is stored in a computer-readable form on a suitable record medium (such as an optical or magneto-optical disk, a magnetic hard disk, an electronic memory) and/or is transferred as optical, electric or electromagnetical signals across a computerized network, and which contains a plurality of program instructions that, when read and executed by a computer, will perform the method according to the invention.

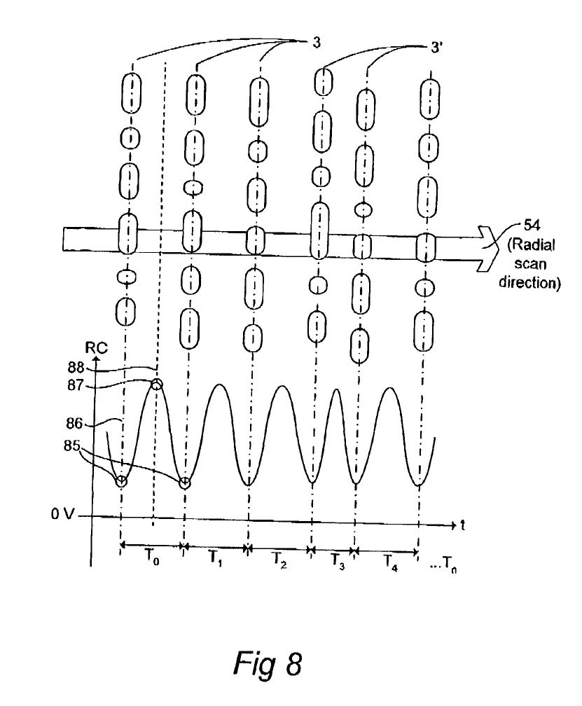

The detection principle described in preceding sections is referred to as one-beam radial push-pull tracking, where the first-order diffraction patterns are utilized so as to generate the Radial Error (RE) signal shown in FIG. 6. However, other types of radial scan principles may be used within the scope of the invention, provided that the functional requirements described herein are fulfilled. For instance, it is envisaged that a Radial Contrast (RC) signal may be used instead of the Radial Error (RE) signal. An example of an RC signal is given in FIG. 8. When generating an RC signal, as is generally known per se in the technical field, zero-order reflections (central aperture of the laser beam) are used instead of the first-order diffraction patterns in the RE signal case.

As shown in FIG. 8, the RC signal has a certain DC level. The RC signal will reach minimum every time the scanning laser beam passes across the centers 86 of the tracks 3 (see reference numeral 85) Moreover, the RC signal will reach local maximums 67 when the laser beam passes the center 88 of the intermediate flat area between adjacent tracks 3. The points 85 or 87 may be used by the time interval measuring unit 34 and the controller 36 for producing the time interval data T₀, T₁, . . . , Tₙ.

The present invention has been described above with reference to a preferred embodiment. However, other embodiments than the one described above are equally possible within the scope of the invention, as defined by the attached patent claims.

1. A local track pitch measuring apparatus for an optical disk (1) of the type that stores optically readable information in the form of a spiral or annular pattern (2) defining a plurality of essentially concentric tracks (3), characterized by
a laser light source (27);
a drive mechanism (20) adapted to project a laser beam spot (22) from the laser light source onto a surface of the optical disk (1) and move the projected laser beam spot radially over a portion of the disk surface across at least some of said tracks (3);
a light detector (24a-b) positioned to detect a diffraction (23a-b) or reflection from the projected laser beam spot during its movement (54), said light detector being adapted to produce a time variant measurement signal (RE), said measurement signal having a periodicity associated with passages of the moving laser beam spot across respective tracks; and
a processing device (36) adapted to determine a local deviation in the periodicity of the measurement signal and in response provide an output (ΔTRP) indicative of a local track pitch for said spiral or annular pattern (2).

2. A local track pitch measuring apparatus as in claim 1, further comprising a time interval measuring device (34) adapted to calculate a sequence of successive full periods (T₀, T₁, . . . , Tₙ) of the measurement signal (RE) and to provide said sequence to said processing device (36).

3. A local track pitch measuring apparatus as in claim 2, wherein the output (ΔTRP) of the processing device (36) is calculated as:
$$Δ {TRP}_{n} = TRP \cdot \frac{{T}_{n} - \frac{{\sum }_{m - n - k}^{n + k} {T}_{m}}{2 k + 1}}{\frac{{\sum }_{m = n - k}^{n + k} {T}_{m}}{2 k + 1}} ,$$
where TRP is a predetermined normal track pitch value for the optical disk (1), ΔTRPₙ is a local track pitch error for a track a, T is any of said full periods, and k is an integer value.

4. A local track pitch measuring apparatus as in claim 2, wherein the output (LTRP) of the processing device (36) is calculated as:
$${LTRP}_{n} = TRP \cdot \frac{{T}_{n}}{\frac{{\sum }_{m = n - k}^{n + k} {T}_{m}}{2 k + 1}} ,$$
where TRP is a predetermined normal track pitch value for the optical disk (1), LTRPₙ is a local track pitch value for a track n, T is any of said full periods, and k is an integer value.

5. A local track pitch measuring apparatus as in any preceding claim, wherein the light detector (24a-b) produces said time variant measurement signal (RE) from first order diffractions (23a-b) from the projected laser beam spot (22).

6. A local track pitch measuring apparatus as in any of claims 1-4, wherein the light detector produces said time variant measurement signal (RC) from zero-order reflections from the projected laser beam spot.

7. A local track pitch measuring apparatus as in any preceding claim, wherein said processing device (36) comprises a programmable microprocessor.

8. A local track pitch measuring apparatus as in any preceding claim, wherein said time variant measurement signal is a Radial Error (RE) or Radial Contrast (RC) signal.

9. A method of measuring local track pitch for an optical disk (1) of the type that stores optically readable information in the form of a spiral or annular pattern (2) defining a plurality of essentially concentric tracks (3), characterized by the steps of
scanning a laser beam spot (22) radially over at least a portion of a surface of the optical disk (1) across at least some of said tracks (3);
detecting a diffraction (23a-b) or reflection from the scanning laser beam spot;
producing a time variant measurement signal (RE) having a periodicity associated with passages of the scanning laser beam spot across respective tracks;
determining a local deviation in the periodicity of the measurement signal; and in response providing an output (ΔTRP) indicative of a local track pitch for said spiral or annular pattern (2).

10. A method as in claim 9, comprising calculating a sequence of successive full periods (T₀, T₁, . . . , Tₙ) of the measurement signal (RE) when determining said local deviation in the periodicity of the measurement signal.

11. A method as in claim 10, wherein said output (ΔTRP) is calculated through the formula:
$$Δ {TRP}_{n} = TRP \cdot \frac{{T}_{n} - \frac{{\sum }_{m = n - k}^{n + k} {T}_{m}}{2 k + 1}}{\frac{{\sum }_{m = n - k}^{n + k} {T}_{m}}{2 k + 1}} ,$$
where TRP is a predetermined normal track pitch value for the optical disk (1), ΔTRPₙ is a local track pitch error for a track n, T is any of said full periods, and k is an integer value.

12. A method as in claim 10, wherein said output (ΔTRP) is calculated through the formula:
$${LTRP}_{n} = TRP \cdot \frac{{T}_{n}}{\frac{{\sum }_{m = n - k}^{n + k} {T}_{m}}{2 k + 1}} ,$$
where TRP is a predetermined normal track pitch value for the optical disk (1), LTRPₙ is a local track pitch value for a track n, T is any of said full periods, and k is an integer value.

13. A method as in any of claims 9-12, wherein said time variant measurement signal is a Radial Error (RE) or Radial Contrast (RC) signal.

14. A computer program product directly loadable into an internal memory (38) associated with a processor (36), comprising program code for performing the steps of any of claims 9-13 when executed by said processor.

15. A computer program product as defined in claim 14, embodied on a computer-readable medium.

16. A computer having a memory (38, 40, 42) and a processor (36), the memory containing program code for performing the steps of any of clams 9-13 when executed by said processor.
